(19) United States
(12) Patent Application Publication
(10) Pub. No.: US 2010/0216020 A1
(43) Pub. Date: Aug. 26, 2010

(54) Battery and Method of Producing Battery

(75) Inventor: Yugo Ito, Kanagawa (JP)

Correspondence Address: Hogan Lovells US LLP, 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/159,368

(22) PCT Filed: Dec. 25, 2006
(86) PCT No.: PCT/JP2006/325803

§ 371 Date: May 10, 2010

(30) Foreign Application Priority Data
Dec. 27, 2005 (JP) 2005-375197
Dec. 27, 2005 (JP) 2005-375266
Dec. 27, 2005 (JP) 2005-375638

(51) Int. Cl. H01M 4/02; H01M 2/00

(52) U.S. Cl. 429/209; 29/623.1

(57) ABSTRACT

A battery comprises a battery cell 11 being in a rectangular plate shape on whose upper side face 11a a negative electrode terminal and a positive electrode terminal are arranged, a negative electrode lead plate 12 and a positive electrode lead plate 13 whose one ends are respectively joined to the negative electrode terminal and positive electrode terminal, and which are arranged on the upper face 11a of the battery cell 11, a battery substrate 14 having mounting metal plates 14c, 14d respectively joined to the negative electrode lead plate 12 and the positive electrode lead plate 13, and electrically connected to the negative electrode terminal and the positive electrode terminal through the mounting metal plates 14c, 14d.

### TECHNICAL FIELD

The present invention relates to a battery and a method of producing a battery, and more specifically, to a battery having a battery cell and a circuit board and a method of producing same.

### RELATED ART

Conventionally, as a battery for a portable mobile terminal device such as a cell phone, there has been known a battery in which a battery cell and a battery substrate is integrally fixed by a resin mold section.

FIG. 9 is an exploded view of a conventional battery. FIG. 10 is to explain welding spots of the battery cell in FIG. 9. As shown in FIG. 9, the conventional battery 1 has a battery cell 2, a battery substrate 3, a terminal cover 4, a positive electrode lead plate 5, a negative electrode lead plate 6, and a connector 7.

The battery cell 2 is a rectangular plate shape on whose long side face the battery substrate 3 is mounted through an adhesive tape 8 for fixing the plate such as a double-sided adhesive tape and the like. The terminal cover 4 made of, for example, PC (polycarbonate) resin is mounted on the battery substrate 3 to cover an external connection terminal placing portion. A positive electrode terminal 2a and a negative electrode terminal 2b are respectively formed on short side faces of the battery cell 2 that are on both sides of the long side face on which the battery substrate 3 is mounted. The positive electrode lead plate 5 and the negative electrode lead plate 6 are respectively joined to the positive electrode terminal 2a and the negative electrode terminal 2b. In addition, the positive electrode lead plate 5 is connected to a connection terminal 3a of the positive electrode of the battery substrate 3, and the negative electrode lead plate 6 is connected to a connection terminal 3b of the negative electrode of the battery substrate 3.

As shown in FIG. 10, the positive electrode lead plate 5 and the negative electrode lead plate 6 are connected to the battery substrate 3 by welding. First, the positive electrode lead plate 5 is welded to the positive electrode terminal 2a of the battery cell 2 on the condition that an end 5a protrudes to the battery substrate 3 (welding 1). Next, the negative electrode lead plate 6 is welded to the negative electrode terminal 2b of the battery cell 2 on the condition that an end 6a protrudes to the battery substrate 3 (welding 2). And then, the end 5a of the positive electrode lead plate 5 protruding to the battery substrate 3 is bent toward the battery substrate 3, piled on the connection terminal 3a of positive electrode of the battery substrate 3 and then welded (welding 3). The end 6a of the negative electrode lead plate 6 protruding to the battery substrate 3 is bent toward the battery substrate 3, piled on the connection terminal 3b of negative electrode of the battery substrate 3, and then welded (welding 4).

After the battery substrate 3 is connected to the positive electrode lead plate 5 and the negative electrode lead plate 6, a resin-molding process is performed using low-temperature molding resin (for example, polyamide resin) with a die (now shown). Thus, the battery substrate 3 is covered with a connector 7 made of a low-temperature molding resin. The connector 7 has a U-shape so as to cover the long side face on which the battery substrate 3 is mounted and short side faces that are on both sides of the long side face of the battery cell 2 (see FIG. 9). The battery substrate 3 on which the terminal cover 4 has been mounted is integrated with the battery cell 2 by the connector 7.

That is, in the conventional battery 1, the positive electrode lead plate 5 and the negative electrode lead plate 6 are respectively drawn out from the positive electrode terminal 2a and the negative electrode terminal 2b which are separated in the longitudinal direction of the battery cell 2. Three side faces, one long side face on which the battery substrate 3 is mount and short side faces that are on both sides of the long side face, are protected by being covered with the connector 7 made of a low-temperature molding resin. As a battery structure like this, there has been known, for example, “a battery and a method of producing a battery” (see Patent Document 1).

### [Patent Document 1] Japanese Patent Application Laid-open No. 2004-296365

### DISCLOSURE OF THE INVENTION

### Problems to be Solved by the Invention

However, as three side faces of the battery cell 2 are covered with the connector 7 made of a low-temperature molding resin, the entire size of the battery pack is inevitably large. Moreover, before the resin-molding process using a low-temperature molding resin is performed with a die, it is necessary to join the positive electrode lead plate 5 and the negative electrode lead plate 6 not only to the battery cell 2 but also to the battery substrate 3 by the welding. Therefore, the welding processes are complicated and a number of processes are required. It also causes an increase in costs.

In other words, the positive electrode terminal 2a and the negative electrode terminal 2b are located on side faces (short side faces) that are different faces from the side face (long side face) on which the battery substrate 3 is mounted. Thus, when the positive electrode lead plate 5 and the negative electrode lead plate 6 are welded, welding directions at the positive electrode terminal 2a and the negative electrode terminal 2b (short side) are different from a welding direction at the battery substrate 3 (long side) (see FIG. 5). Therefore, separate processes are required to weld the positive electrode lead plate 5 and the negative electrode lead plate 6. Moreover, processes for bending the positive electrode lead plate 5 and the negative electrode lead plate 6 are respectively required.

An object of the present invention is to provide a battery and a battery producing method that can make a size of entire battery pack smaller and cut down the cost by reducing the number of processes for jointing a battery substrate.

### Means for Solving the Problem

To achieve the above object, a battery according to the first invention comprises a battery cell being in a rectangular plate shape on whose one side face a negative electrode terminal and a positive electrode terminal are arranged; a negative electrode lead plate and a positive electrode lead plate whose one ends are respectively joined to the negative electrode terminal and the positive electrode terminal, and which are arranged on the side face of the battery cell; a battery substrate having mounting metal plates respectively joined to the negative electrode lead plate and the positive electrode lead plate, and electrically connected to the negative electrode terminal and the positive electrode terminal through the mounting metal plates, the negative electrode lead plate and a positive electrode lead plate.

In the battery according to the second invention, the negative electrode lead plate is arranged so that a joint portion joined to the mounting metal plate is positioned on an edge side of one longitudinal side of the side face, the positive electrode lead plate is placed so that a joint portion joined to the mounting metal plate is positioned on an edge side of the other longitudinal side of the side face, and the battery substrate is arranged between two joint portions of the negative electrode lead plate and the positive electrode lead plate.

In the battery according to the third invention, the mounting metal plates are mounted on the side-face side of the battery substrate.

In the battery according to the fourth invention, the battery substrate has the mounting metal plate joined to the negative electrode lead plate on an edge side of one longitudinal side of the side face, and the mounting metal plate joined to the positive electrode lead plate on an edge side of the other longitudinal side of the side face.

In the battery according to the fifth invention, the battery substrate is integrated with the battery cell by being covered with a resin mold section.

In the battery according to the sixth invention, joint portions of the negative electrode lead plate and the positive electrode lead plate are arranged so as to form a single plane along the side face.

In the battery according to the seventh invention, joining of the negative and positive electrode lead plates and the battery cell, and joining of the negative and positive electrode lead plates, and the mounting metal plates of the battery substrate are performed in the same direction.

In the battery according to the eighth invention, the battery substrate has an external connection terminal electrically connected to the negative electrode terminal and the positive electrode terminal, and the external connection terminal is positioned on the generally longitudinal center of the side face when the battery substrate is mounted facing the side face.

The battery according to the ninth invention further comprises a terminal cover arranged so as to cover the battery substrate, wherein the external connection terminal is exposed through an external terminal window provided on the terminal cover.

The battery according to the tenth invention further comprises resin mold sections arranged on both longitudinal sides of the terminal cover, respectively.

In the battery according to the eleventh invention, the resin mold sections are molded by injecting a resin material from injection gates of a resin mold forming die arranged with facing the side face on both longitudinal sides of the terminal cover toward the side face on both sides of the terminal cover.

In the battery according to the twelfth invention, the terminal cover is mounted on the battery substrate, and the resin mold sections are integrally joined with the terminal cover.

The battery according to the thirteenth invention further comprises a battery label that covers and wraps joint portions of the terminal cover and the resin mold sections.

In the battery according to the fourteenth invention, the battery substrate has an external connection terminal which is electrically connected to the negative electrode terminal and the positive electrode terminal and exploded by a terminal cover arranged so as to cover the battery substrate, and a repulsion means for applying a compression repulsive force to the battery substrate toward the terminal cover is arranged between the battery cell and the battery substrate.

In the battery according to the fifteenth invention, the repulsion means is arranged in a compressed state in order to closely contact the battery substrate with the terminal cover by biasing the battery substrate against the terminal cover with the compression repulsive force.

A method of producing a battery according to the sixteenth invention comprises steps of: joining one ends of a negative electrode lead plate and a positive electrode lead plate to a negative electrode terminal and a positive electrode terminal, respectively, arranged on one side face of a battery cell being in a rectangular plate shape; joining mounting metal plates which are provided on both ends of a battery substrate to the negative electrode lead plate and the positive electrode lead plate; and injecting a resin material from a side facing the side face toward the battery substrate to form resin mold sections by which the battery substrate is covered and integrated with the battery cell.

### EFFECT OF THE INVENTION

According to the present invention, a battery cell consisting of a rectangular plate shape has a negative electrode terminal and a positive electrode terminal arranged on one side face thereof, and a negative electrode lead plate whose one end is joined to the negative electrode terminal and a positive electrode lead plate whose one end is joined to the positive electrode terminal are arranged on the side face. A battery substrate has mounting metal plates respectively joined to the negative electrode lead plate and the positive electrode lead plate on both sides, and is electrically connected to the negative electrode terminal and the positive electrode terminal through the mounting metal plate, the negative electrode lead plate and the positive electrode lead plate.

Therefore, the entire size of the battery pack can be avoided from getting larger but can be reduced, and costs can be cut down by reducing the number of processes necessary for joining the battery substrate.

### BRIEF DESCRIPTION OF THE DRAWINGS

FIG. 1 is an illustrative view of a rear side of a mobile phone to which a battery according to an embodiment of the present invention is to be mounted;

FIG. 2 is an exploded view of the battery of the FIG. 1;

FIG. 3 is a front view showing welding spots on the battery cell of FIG. 2

FIG. 4 is a front view of the battery cell after forming a resin mold section;

FIG. 5 is an illustrative view showing injection directions of a resin when resin mold sections are formed by a die;

FIG. 6 is an illustrative view showing the relation between pressure applied to the terminal cover and a double-sided adhesive foam tape when resin mold sections are formed by a die;

FIG. 7 is an illustrative view showing the double-sided adhesive foam tape when the battery substrate is mounted on the battery cell;

FIG. 8 is a partial front view of the battery cell showing a wrapping condition of the battery label at both resin mold sections;

FIG. 9 is an exploded view of a conventional battery; and

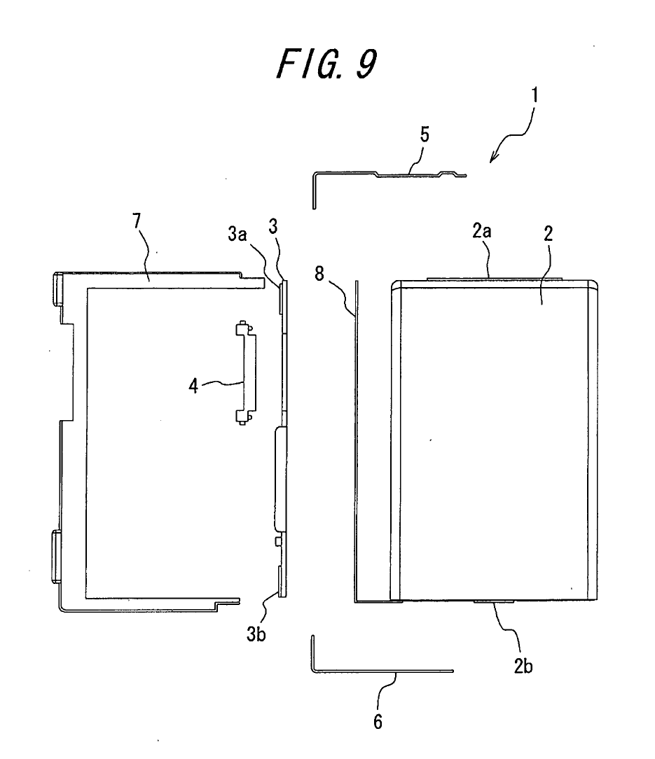

FIG. 10 is an illustrative view of welding spots of the battery cell in FIG. 9.

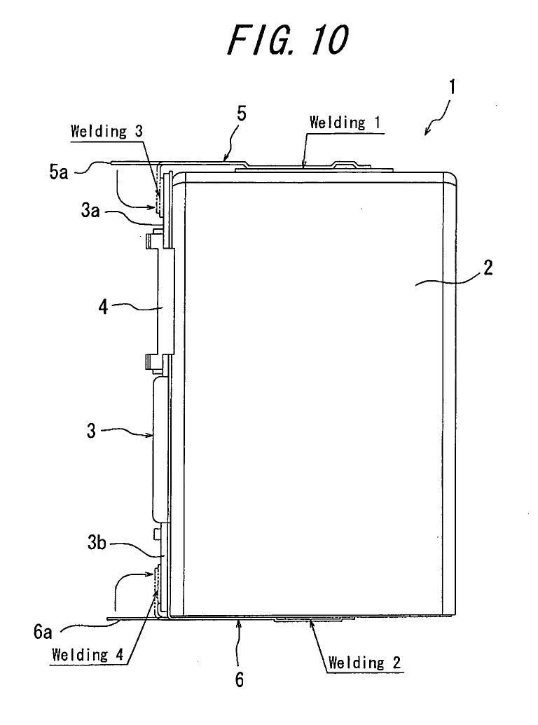

### DESCRIPTION OF THE NUMERALS

10 battery
10a external connection terminal
11 battery cell
11a upper face
11b lower face
11c right side face
11d left side face
12 negative electrode lead plate
12a contact portion
12b joint portion
12c concave portion
13 positive electrode lead plate
13a contact portion
13b joint portion
13c step portion
14 battery substrate
14a substrate body
14b swollen portion
14c, 14d mounting metal plate
15 terminal cover
15a opening portion
16a, 16b resin mold section
17 protruding end section
18 double-sided adhesive tape
19 resin mold forming die
19a injection gate
20 battery label
20a wrapping portion
C cover
S mobile phone
Sh housing section
Sc connector

### BEST MODE FOR CARRYING OUT THE INVENTION

Best mode for carrying out the present invention will now be described with reference to the accompanying drawings.

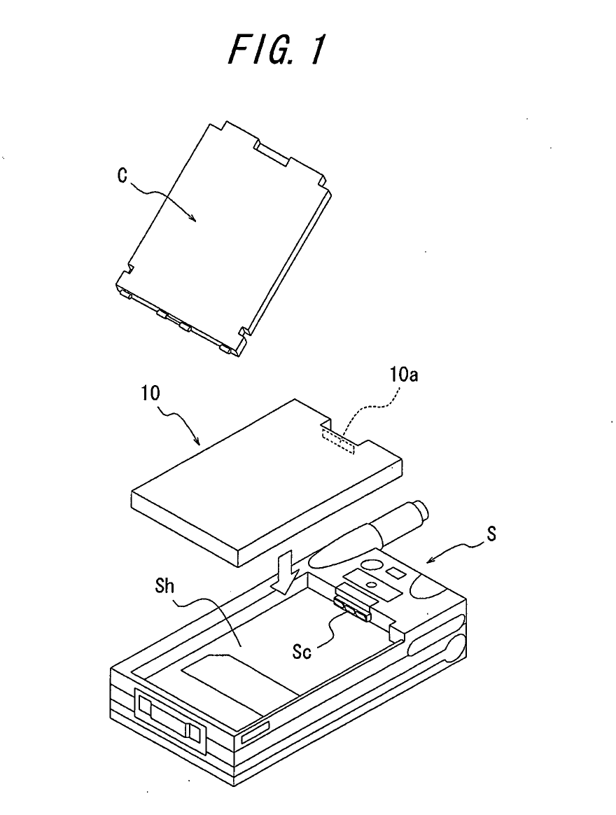

FIG. 1 is an exploded illustrative view of the rear side of a mobile phone to which a battery according to an embodiment of the present invention is to be mounted. As shown in FIG. 1, a battery 10 is mounted into a portable mobile terminal device such as a mobile phone S. The battery 10 is inserted, for example, in a concave-shaped housing section Sh formed on the rear side of the mobile phone S in such a state that an external connection terminal 10a of the battery 10 is connected to the connector Sc of the housing section Sh. The housing section Sh in which the battery 10 is mounted is closed with a cover C.

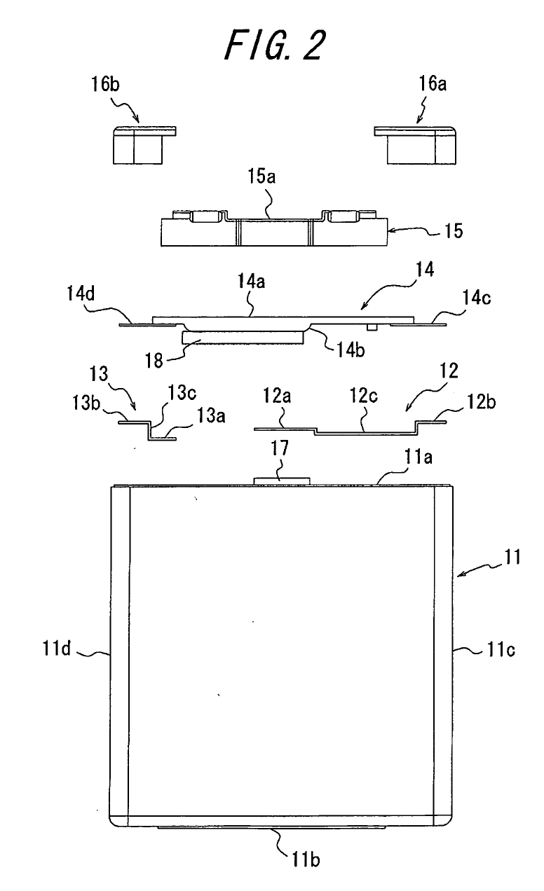

FIG. 2 is an exploded view of the battery of FIG. 1. As shown in FIG. 2, the battery 10 comprises a battery cell 11, a negative electrode lead plate 12, a positive electrode lead plate 13, a battery substrate (circuit board) 14, a terminal cover 15, and two resin mold sections 16a, 16b.

The battery cell 11 is a rectangular plate shape and has an upper face 11a and a lower face 11b facing each other, and a right side face 11c and a left side face 11d facing each other. There is formed, on the upper face 11a, a negative electrode terminal which is composed of a protruding section 17 positioned on the substantially longitudinal center of the upper face 11a, and a positive electrode terminal which is composed of nearly entire upper face 11a except the protruding section (the negative electrode terminal) 17. In other words, the negative electrode terminal and the positive electrode terminal are arranged on the upper face 11a that is one side face of the battery cell 11. The battery substrate 14 has the external connection terminal 10a electrically connected to the negative electrode terminal and the positive electrode terminal, and is arranged to face the upper face 11a. A terminal cover 15 and two resin mold sections 16a, 16b are mounted to cover the battery substrate 14 and the upper face 11a. The external connection terminal 10a is provided on the battery substrate 14 so that it is positioned on the generally longitudinal center of the upper face 11a when the battery substrate 14 is arranged to face the upper face 11a. It is noted that hereinafter, the side face having the protruding section 17 is referred to as an upper face of the battery cell 11 (see FIG. 2).

The negative electrode lead plate 12 is composed of a metal plate that is bent via a concave portion 12c generally along the step shape by the protruding section 17 and the upper face 11a so that, on the condition that a contact portion 12a which is a flat portion of one end is placed on the protruding section 17 and is contacted with a top face of the protruding section 17, a joint portion 12b which is a flat portion of the other end is positioned above the right side face 11c side of the upper face 11a, in other words, above edge of the upper face 11a. The amount of the step of the contact portion 12a side of the concave portion 12c is smaller than the amount of the protrusion (height) of the protruding section 17 from the upper face 11a. The amount of the step of the joint portion 12b side of the concave portion 12c is larger than the amount of the protrusion of the protruding section 17 from the upper face 11a. Moreover, an isolation sheet (not shown) is interposed between a surface of the battery cell 11 side (the lower side in FIG. 2) of the concave portion 12c and the upper face 11a of the battery cell 11. In other words, on the condition that the contact portion 12a is placed on the protruding section 17, the concave portion 12c is apart from the upper face 11a without being contacted, and the joint portion 12b is further above the protruding section 17. Therefore, the negative electrode lead plate 12 is electrically connected to the battery cell 11 through only the contact portion 12a.

The positive electrode lead plate 13 is composed of a metal plate bent in a step shape through a step portion 13c so that, on the condition that a contact portion 13a which is a flat portion of one end is placed on the upper face 11a and contacted with it, a joint portion 13b which is a flat portion of the other end is positioned above the left side face 11d side of the upper face 11a, in other words, above edge of the upper face 11a. The step portion 13c has the amount of the step larger than that of the joint portion 12b side of the negative electrode lead plate 12. The joint portion 13b has the substantially same length with the joint portion 12b.

Moreover, joint portions 12b, 13b of the negative and positive electrode lead plates 12, 13, respectively, are arranged so as to form one plane along the upper face 11a by adjusting the amounts of the steps of the concave portion 12c and the step portion 13c to, for example, make the joint portions 12b and 13b in parallel with the upper face 11a.

The battery substrate 14 has a swollen portion 14b formed on the rear face (lower face) of a portion of a substrate body 14a on which circuits (not shown) are printed, the portion being around the longitudinal center on which the external connection terminal (not shown) is formed. The battery substrate 14 also has mounting metal plates 14c, 14d mounted on both ends of rear face facing the upper face 11a. The mounting metal plate 14c is fitted so that the amount of the projection beyond the board 14a is substantially same with the joint portion 12b, and the mounting metal plate 14d is fitted so that the amount of the protrusion beyond the board 14a is substantially same with the joint portion 13b. Therefore, the battery substrate 14 has the longitudinal length and plane shape that are substantially same with those of the upper face 11a of the battery cell 11 in its entirety.

As the lower face of the battery substrate 14 has the swollen portion 14b on which surface-mount components are arranged, the lower face is not a flat face but an uneven face. A tape-shaped double-sided adhesive foam tape 18 produced by providing adhesive layers on both faces of a flat foam is stuck to the lower face of the swollen portion 14b. The double-sided adhesive foam tape 18 is placed between the battery substrate 14 and the upper face 11a of the battery cell 11, so that the battery substrate 14 is temporarily fixed to the battery cell 11 for positioning its location. In addition, by the compression of the double-sided adhesive foam tape 18, a compression repulsive force works from the battery cell 11 toward the battery substrate 14. In other words, the double-sided adhesive foam tape 18 has a thickness larger than the distance between the battery cell 11 and the battery substrate 14, in other words, has a thickness enough to produce the compression repulsive force, so that it serves as a repulsion means for giving repulsive force to the battery substrate 14 toward the terminal cover 15.

The terminal cover 15 is composed of a curved plate which is made of, for example, PC (polycarbonate) resin, has a longitudinal length shorter than the battery substrate 14, and has a cross section curved downward like a U-shape in a direction perpendicular to the longitudinal direction. It has an opening portion 15a for exposing the external connection terminal (not shown) of the battery substrate 14, on the approximate center of the longitudinal side. The terminal cover 15 is mounted on the battery substrate 14 from above, and then, is engaged with the battery substrate 14 by an engaging portion (not shown) so that an upward movement is restricted from a predetermined position.

Two resin mold sections 16a, 16b are formed by a resin-molding process using a low-temperature molding resin (for example, polyamide resin) which is a resin material. Both resin mold sections 16a, 16b are arranged on both longitudinal sides of the terminal cover 15 and have shapes corresponding to terminal covers 15 to be substantially integrated with terminal covers 15, respectively. In addition, the resin mold sections 16a, 16b are formed to block wall portions of the right side face 11c side and the left side face 11d side of the terminal cover 15, respectively, without making an opening.

These two resin mold sections 16a, 16b are mounted on the upper face 11a of the battery cell 11 with the terminal covers 15 on both longitudinal sides of the terminal cover 15, so that resin mold sections 16a, 16b are integrated with the battery cell 11 in a shape of extending and enlarging the battery cell 11 toward the upper face 11a side.

The battery 10 is formed by sequentially mounting the components described above on the battery cell 11. After the negative electrode lead plate 12 and the positive electrode lead plate 13 are arranged on the battery cell 11, the positive electrode lead plate 13 and the negative electrode lead plate 12 are joined to the upper face 11a and the protruding end section 17, respectively, by being welded or soldered. In addition, mounting metal plates 14c, 14d of the battery substrate 14 are respectively placed on the joint portions 12b, 13b of the negative and positive electrode lead plates 12, 13 and then are joined by being welded or soldered.

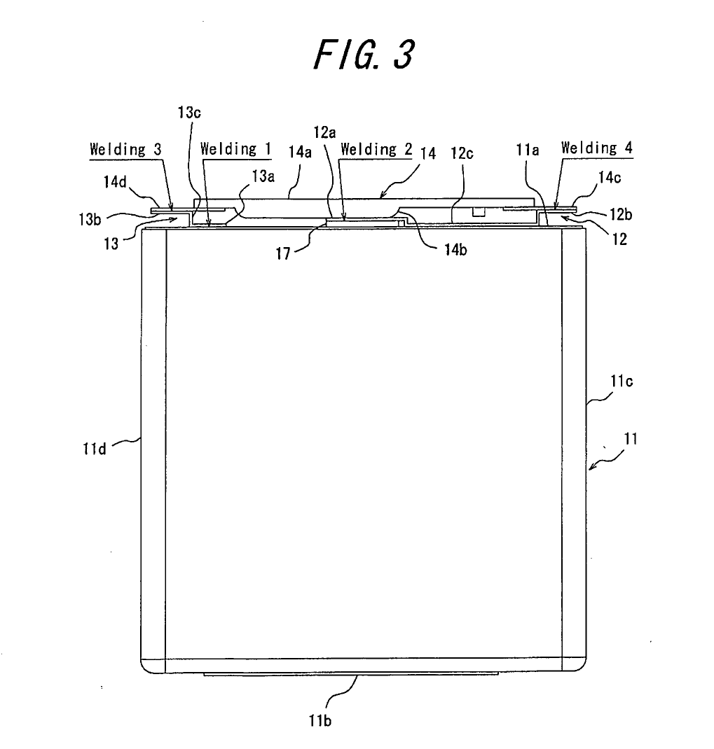

FIG. 3 is a front view showing welding spots on the battery cell of FIG. 2. As shown in FIG. 3, the contact portion 13a of the positive electrode lead plate 13 is placed on the upper face (the positive electrode) 11a of the battery cell 11, so that the positive electrode lead plate 13 is arranged on the positive electrode. At this time, the joint portion 13b is located for its free-end to be near the left side face 11d on the upper face 11a (see FIG. 3). The contact portion 13a is welded and contacted with the upper face 11a from above the upper face 11a (welding 1).

Next, the contact portion 12a of the negative electrode lead plate 12 is placed on the protruding section (negative electrode terminal) 17, so that the negative electrode lead plate 12 is arranged on the negative electrode terminal. At this time, the joint portion 12b is located for its free-edge to be near the right side face 11c on the upper face 11a (see FIG. 3). The contact portion 12a is joined to the protruding section 17 by being welded from above the upper face 11a (welding 2).

Then, the battery substrate 14 is placed on the positive electrode lead plate 13 and the negative electrode lead plate 12 fixed to the battery cell 11 so that the swollen portion 14b faces the contact portion 12a; the mounting metal plate 14c faces the joint portion 12b; and the mounting metal plate 14d faces the joint portion 13b. At this time, the mounting metal plates 14c, 14d are respectively piled on the joint portions 12b, 13b so that their free-ends correspond to free-ends of the joint portions 12b, 13b, respectively. As the result, a gap for arranging the board 14a of the battery substrate 14 is secured between an end of the step portion 13c side of the joint portion 13b and an end of the concave portion 12c side of the joint portion 12b (see FIG. 3)

Thereafter, the mounting metal plate 14d is joined to the joint portion 13b by being welded from above the upper face 11a (welding 3). Subsequently, the mounting metal plate 14c is joined to the joint portion 12b by being welded from above the upper face 11a (welding 4).

In this way, welding processes are performed on four spots: two spots for welding (welding 1, welding 2) of the battery cell 11 and positive and negative electrode lead plates 13, 12; and two spots for welding (welding 3, welding 4) of positive and negative electrode lead plates 13, 12 and the battery substrate 14. However, welding directions at the four spots are the same with one another, in other words, welding processes are performed from above the upper face 11a.

That is, the welding spots between negative and positive electrode lead plates 12, 13 and battery cell 11 are on the protruding section 17 and the upper face 11a, respectively. The welding spots between negative and positive electrode lead plates 12, 13 and battery substrate 14 are on joint portions 12b, 13b of the negative and positive electrode lead plates 12, 13. Therefore, all spots are located on the upper face 11a side, and located on a single moving track of a welding means (joining means).

In addition, there is no need to bend the positive electrode lead plate 13 and the negative electrode lead plate 12 when welding.

Thereafter, the terminal cover 15 is mounted on the battery substrate 14 connected to positive and negative electrode lead plates 13, 12, and engaged with the battery substrate 14.

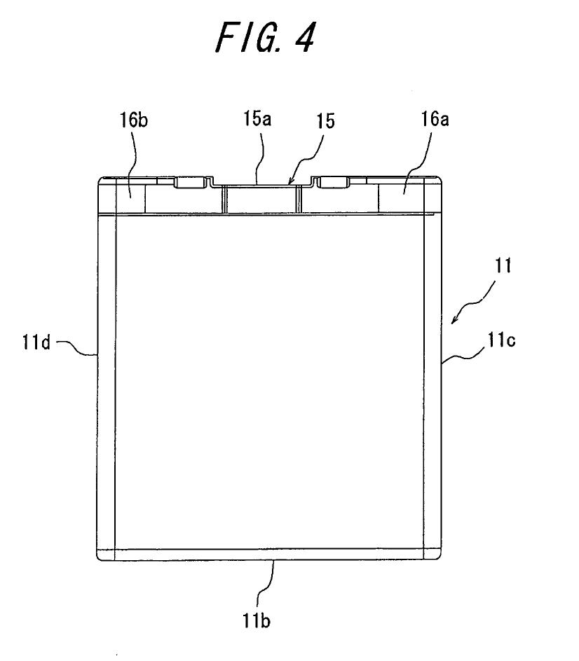

FIG. 4 is a front view of the battery cell after resin molding. As shown in FIG. 4, after the terminal cover 15 is mounted on the battery substrate 14, the resin-molding process is performed by a low-temperature molding resin injected from above the upper face 11a toward the battery substrate 14 using a die (not shown), so that the resin mold sections 16a, 16b made of the low-temperature molding resin are molded on both sides of the terminal cover 15.

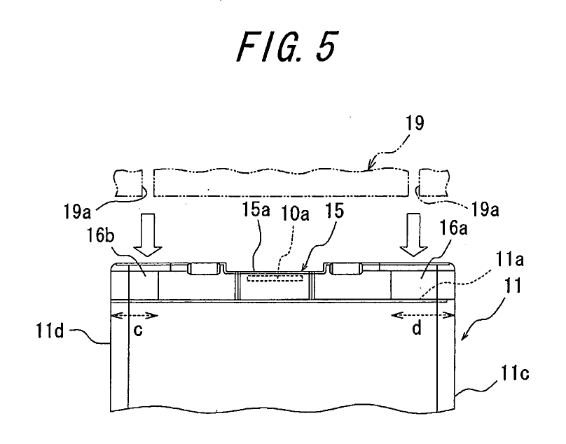

FIG. 5 is an illustrative view showing injecting directions of resin when molding the resin mold sections. As shown in FIG. 5, after the battery substrate 14 is mounted on the upper face 11a, and the terminal cover 15 is mounted on the battery substrate 14, the resin-molding process using a low-temperature molding resin is performed with a resin mold forming die 19. The resin mold sections 16a, 16b made of low-temperature molding resin are formed on both sides of the terminal cover 15 by the resin-molding process.

The resin mold forming die 19 is provided with two injection gates 19a, 19a for injecting the low-temperature molding resin on both longitudinal sides of the terminal cover 15, the injection gates 19a, 19b being arranged to face the upper face 11a of the battery cell 11. Both injection gates 19a, 19a are arranged to be substantially perpendicular to the upper face 11a, and the low-temperature molding resin is injected from each injection gate 19a toward the upper face 11a on each side of the terminal cover 15 in a direction substantially perpendicular to the upper face 11a (see white blank arrows in FIG. 5).

Now, the molding process for the resin mold sections 16a, 16b using the resin mold forming die 19 will be described. First, a battery unit is formed by mounting the battery substrate 14 equipped with the terminal cover 15 on the upper face 11a of the battery cell 11 and electrically connecting the battery substrate 14 to the negative electrode terminal and the positive electrode terminal of the battery cell 11 through connection members (not shown). Next, the battery unit is put in the resin mold 18 so that the top face of the terminal cover 15 abuts on the end face of the resin mold forming die 19. Accordingly, two cavities (not shown) are formed on both longitudinal sides of the upper face 11a within the resin mold forming die 19.

Then, a resin material made of soften low-temperature molding resin is injected from each opening injection gate 19a toward corresponding cavity to fill the cavity, so that the resin material is provided in each cavity that is the place for the resin mold section. Thereafter, the resin material in each cavity is cured to form resin mold sections 16a, 16b on the upper face 11a side of the battery cell so as to cover the battery substrate 14 and the connection member.

At this time, as the external connection terminal 10a is on the substantially longitudinal center of the upper face 11a, molding ranges of resin mold sections provided on right and left sides of the external connection terminal 10a (right and left sides of the terminal cover 15) have substantially same contact distance with the upper face 11a with each other (see arrows c and d in the figure). Moreover, they have substantially same adhesion area between the battery cell 11 and the low-temperature molding resins.

Accordingly, it is possible to maximize the adhesion area between the battery cell 11 and low-temperature molding resins on right and left sides, and to secure the adhesion area enough to prevent the low-temperature molding resins from being exfoliated. Moreover, since the low-temperature molding resin is filled until it reaches substantially a half of the upper face 11a in the longitudinal direction and the both sides of the upper face 11a are equally filled with the low-temperature molding resins, the injected low-temperature molding resin can be easily reach to the edge without making an unfilled area, so that it is possible to prevent a short mold. Therefore, it is easy to set the molding conditions.

After two resin mold sections 16a, 16b are formed, the battery cell where the terminal cover 15 and both resin mold sections 16a, 16b are integrated is in the state of exposing the external connection terminal 10a through the opening portion 15a on the upper face 11 side (see FIG. 5).

In this way, the battery 10 is provided with the negative electrode terminal and the positive electrode terminal on one side face (upper face 11a) of the battery cell 11. In this connection, battery components including the battery substrate 14, the terminal cover 15 and two resin mold sections 16a, 16b are intensively arranged on this side face (upper face 11a), and the external connection terminal 10a is also placed on the substantially longitudinal center of this side face (upper face 11a). In other words, as the external connection terminal 10a is arranged on the center of the side face, mountability of the battery 10 in the housing section Sh of the mobile phone S is improved. In addition, because the battery 10 is equally pressed down without tilting to a biasing member such as a spring when being loaded, abrasion caused at that time is substantially reduced.

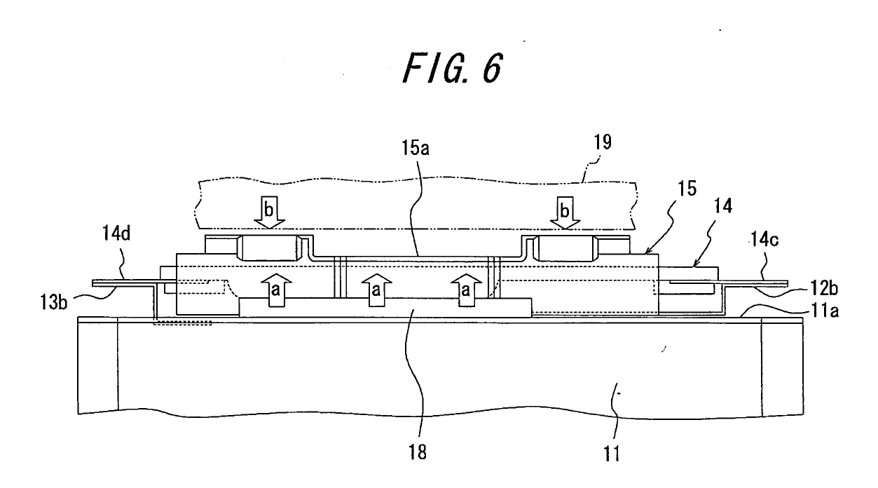

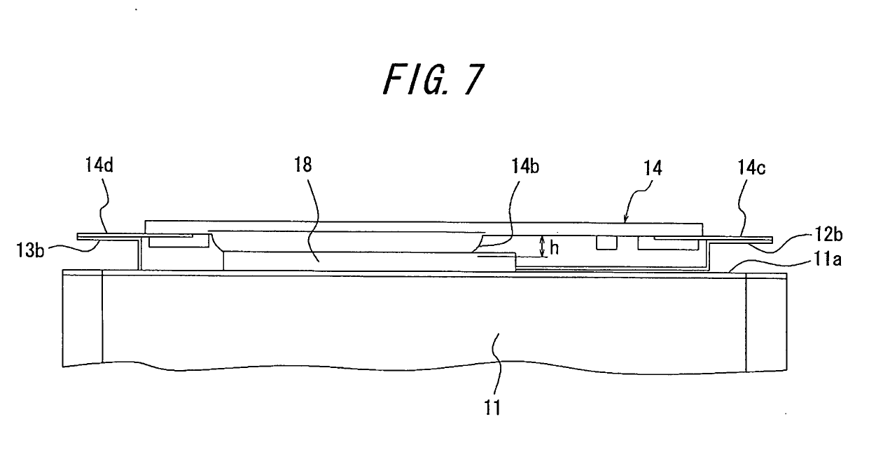

FIG. 6 is an illustrative view showing relation between the pressure (biasing force) applying to the terminal cover 15 and double-sided adhesive foam tape when resin mold sections 16a, 16b are molded. FIG. 7 is an illustrative view showing the double-sided adhesive foam tape 18 when the battery substrate 14 is mounted on the battery cell 11.

As shown in FIG. 6, after the battery substrate 14 is mounted on the upper face 11a of the battery cell 11 and then the terminal cover 15 is mounted on the battery substrate 14, the resin-molding process using the low-temperature molding resin is performed with the resin mold forming die 19. Through this resin-molding process, resin mold sections 16a, 16b made of the low-temperature molding resin are formed on the both sides of the terminal cover 15.

On the resin mold forming die 19, two injecting gates 19a for injecting low-temperature molding resin are formed on both sides of the terminal cover 15 with facing the upper face 11a of the battery cell 11. Both injecting gates 19a are arranged in a direction perpendicular to the upper face 11a, and the low-temperature molding resin is injected from each injecting gate 19a towards the upper face 11a on both sides of the terminal cover 15 in the direction perpendicular to the upper face 11a.

Now, the molding process for the resin mold sections 16a, 16b using the resin mold forming die 19 will be described. First, a battery unit is formed by mounting the battery substrate 14 equipped with the terminal cover 15 on the upper face 11a of the battery cell 11, and electrically connecting the battery substrate 14 to the negative electrode terminal and the positive electrode terminal through the connection member (negative electrode lead plate 12, positive electrode lead plate 13, mounting metal plates 14c, 14d). By means of welding, soldering or the like, the negative electrode terminal of the battery cell 11 is joined to the negative electrode lead plate 12; the positive electrode terminal of the battery cell 11 is joined to the positive electrode lead plate 13; the negative electrode lead plate 12 is joined to the mounting metal plate 14c; and the positive electrode lead plate 13 is joined to the mounting metal plate 14d.

At this time, the double-sided adhesive foam tape 18 between the battery cell 11 and the battery substrate 14 is compressed due to the relation between distance of the battery cell 11 and the battery substrate 14 and the thickness of the double-sided adhesive foam tape 18. By the double-sided adhesive foam tape 18, a compression repulsive force of the double-sided adhesive foam tape 18 operates from the battery cell 11 toward the battery substrate 14 (see arrows a in the FIG. 6). In other words, the double-sided adhesive foam tape 18 is placed with being compressed in order to apply (bias) the pressure to the battery substrate 14 and to contact the battery substrate 14 with the terminal cover 15 closely by the compression repulsive force. At the same time, the double-sided adhesive foam tape 18 absorbs the irregular depth of swollen portion 14b for arranged mount devices, in other words, variation on distance of the battery substrate 14 in the height direction (see FIG. 7).

Next, the battery unit is put in the resin mold forming die 19, and two cavities (not shown) are formed on both longitudinal sides of the upper face 11a within the die 19. At this time, the terminal cover 15 on the outermost side (the top side in the FIG. 6) of the battery unit contacts the resin mold forming die 19. In addition, the top side of the battery cover 15 receives a pressing force acting toward the battery cell 11 from the resin mold forming die 19 according to the compression repulsive force of the double-sided adhesive foam tape 18 which the terminal cover 15 receives through the battery substrate 14 (see arrow b in FIG. 6). In other words, as the terminal cover 15 is put in the resin mold forming die 19 under the condition of abutting with the resin mold forming die 19, the double-sided adhesive foam tape 18 becomes into the compressed condition, and the compression repulsive force of double-sided adhesive foam tape 18 works from the battery substrate 14 towards the terminal cover 15.

Accordingly, the pressure is always applied to the battery substrate 14 and the terminal cover 15 in the direction they contact with each other.

Next, a resin material made of soften low-temperature molding resin is injected from each opening injecting gate 19a to fill each cavity, so that the resin material is provided to each cavity which is the place for molding the resin mold section. At this time, the resin material is injected to the compressed direction of the double-sided adhesive foam tape 18. Then, the resin material in each cavity is cured to form the resin mold sections 16a, 16b so as to cover a part of the battery substrate 14 and the terminal cover 15 on the upper face 11a side of the battery cell 11, in other words, on both sides of the terminal cover 15 of the battery unit.

As described above, the double-sided adhesive foam tape 18 is stuck to the rear face of the battery substrate 14 in order to closely contact the battery substrate 14 with the terminal cover 15 arranged on the battery substrate 14. By using the compression repulsive force of the double-sided adhesive foam tape 18, the pressure is applied to the battery substrate 14, and thus the battery substrate 14 is closely contacted with the terminal cover 15. Therefore, it is possible to prevent leak of the low-temperature molding resin into the gap between the terminal cover 15 and the battery substrate 14. Moreover, it is possible to prevent the external terminal window 15a of the terminal cover 15, in other words, external connection terminal 10a from being blocked by the low-temperature molding resin. At this time, since the pressure is applied to the entire surface of the battery substrate 14, stress is not concentrated to a local portion of the battery substrate 14.

The double-sided adhesive foam tape 18 absorbs variation on distance h of the battery substrate 14 in the height direction due to the surface-mounted component on the battery substrate 14. In addition, as the double-sided adhesive foam tape 18 is used instead of a double-sided adhesive tape for temporary fixing the battery substrate 14 to the battery cell 11, and it also has a function for temporary fixing, the number of devices is not increased.

As described above, the negative electrode terminal and the positive electrode terminal are arranged on one side face (upper face 11a) of the battery cell 11. On this side face (upper face 11a), battery components comprising battery substrate 14, terminal cover 15 and two resin mold sections 16a, 16b intensively are arranged. Therefore, although four welding spots for joining the battery cell 11 with the battery substrate 14 are needed as conventional, it is possible to weld in the same direction at the four welding spots. Accordingly, joining the contact portion 13a to the upper face 11a (welding 1), joining the contact portion 12a to the protruding section 17 (welding 2), joining the mounting metal plate 14d to the joint portion 13b (welding 3) and joining the mounting metal plate 14c to the joint portion 12b (welding 4) can be performed by the same process with devising a jig, and can be performed by two welding operations with the shortest route. Moreover, bending the positive electrode lead plate 13 and the negative electrode lead plate 12 in the assembling process when welding is not needed, so that it is possible to reduce processes.

Moreover, as covering the battery cell 11 with the low-temperature molding resin by the resin-molding process is performed at only one side face (upper face 11a), it is possible to reduce size of the battery pack.

A battery according to the present invention comprises a battery cell being in a rectangular plate shape on whose one side face a negative electrode terminal and a positive electrode terminal are arranged; a negative electrode lead plate and a positive electrode lead plate whose one ends are respectively joined to the negative electrode terminal and the positive electrode terminal, and which are arranged on the side face of the battery cell; and a battery substrate having mounting metal plates respectively placed on the negative electrode lead plate and the positive electrode lead plate on both sides, and electrically connected to the negative electrode terminal and the positive electrode terminal through the mounting metal plates.

Also, joint portions of the negative and positive electrode lead plates are arranged to form one plane along the side face, and joint spots between the negative electrode lead plate and the positive electrode lead plate and the battery cell, and joint spots between the negative electrode lead plate and the positive electrode lead plate and the battery substrate are positioned on the same moving track of a joining means.

Accordingly, the negative electrode terminal and the positive electrode terminal are arranged on one side of the battery cell, and the negative electrode lead plate joined to the negative electrode terminal, the positive electrode lead plate joined to the positive electrode terminal, and mounting metal plates that are respectively mounted on negative and positive electrode terminal sides of the battery substrate have joint portions along the side face of the battery cell. Therefore, when corresponding members are joined by being welded or soldered, joining processes are performed from the same direction (for example, a direction perpendicular to the side face), so that it is possible to reduce the number of assembling processes. Further, as the battery substrate and the resin mold portion are arranged on one side face, it is possible to compactly construct the battery.

Also, the negative electrode lead plate has a joint portion on which the mounting metal plate is placed and joined, and which is positioned on an end of one side of a side face. The positive electrode lead plate has a joint portion on which the mounting metal plate is placed and joined, and which is positioned on an end of the other side of the side face. The battery substrate is arranged between both joint portions of negative and positive electrode lead plates.

Therefore, as the joint portion (which is on the negative electrode side) of the negative electrode lead plate and the joint portion (which is on the positive electrode side) of the positive electrode lead plate are arranged on edge portions more outside than contact portions of lead plates with the battery cell (negative electrode terminal, positive electrode terminal) in the longitudinal direction, and a battery substrate is placed between both joint portions, it is possible to compactly construct a battery with keeping the degree of freedom for arranging the battery substrate.

The mounting metal plates are mounted on one surface of the battery substrate. Thus, the battery substrate is supported by the battery cell at the rear face through the lead plates and the mounting metal plates, so that it is possible to improve the support rigidity of the battery substrate to the battery cell. Especially, when the resin material is injected from above one side face, the resin material is injected toward a surface of the battery substrate (the upper face in FIG. 3), so that stress operates to the battery substrate toward the side face of the battery cell and, as the result, the stress operates to the joint portion between the battery substrate and the mounting metal plate. Therefore, it is possible to reduce stress operating to the joint portion between the battery substrate and the mounting metal plate.

The battery substrate is integrated with the battery cell by resin mold sections that are molded by the resin material injected from above one side face toward the battery substrate. Accordingly, as the resin material is injected from above one side face, i.e., in a direction perpendicular to joint portions between battery cell and lead plates and between lead plates and mounting metal plate, and, as the resin material is not injected directly toward one side face of the battery cell, it is possible to suppress the influence (stress) of the resin material on the battery cell, and to prevent deformation of the battery cell.

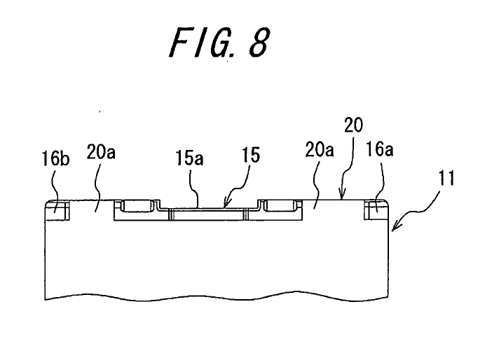

Next, wrapping construction of a battery label is described. FIG. 8 is a partial front view of the battery cell showing a wrapping condition of the battery label at both resin mold sections. As shown in FIG. 8, after the terminal cover 15 and both resin mold sections 16a, 16b are formed to be integrated with the battery cell 11, the battery label (seal member) 20 is attached to cover almost entire surface of the battery cell 11. In other words, the battery label 20 is attached to cover entire surface of the battery unit composed of the terminal cover 15 and two resin mold sections 16a, 16b integrated with the battery cell 11.

At this time, the battery label 20 wraps so that a wrapping portion 20a of convex shape reaches to the terminal cover 15 and both resin mold section 16a, 16b. Therefore, a joint portion between the terminal cover 15 and the resin mold section 16a and a joint portion between the terminal cover 15 and the resin mold section 16b are covered with the wrapping portion 20a of the battery label 20.

As the terminal cover 15 and both resin mold sections 16a, 16b are integrated and then covered with the battery label 20, it is possible to prevent the both resin mold resin sections 16a, 16b made of low-temperature molding resin from being exfoliated from the battery substrate 14, in other words, from being exfoliated from the battery cell 11.

In this way, according to this embodiment, a battery cell being in a rectangular plate shape has a negative electrode terminal and a positive electrode terminal arranged on one side face. On the side face of the battery cell, a negative electrode lead plate whose one end is joined to the negative electrode terminal, and a positive electrode lead plate whose one end is joined to the positive electrode terminal are arranged. A battery substrate has mounting metal plates placed on the negative electrode lead plate and the positive electrode lead plate and joined to, respectively, on both sides, and is electrically connected to the negative electrode terminal and positive electrode terminal through the mounting metal plates and the both lead plates. Therefore, the entire size of the battery pack is not made to be large but can be made to be small. In addition, it is possible to cut down costs by reducing the number of processes for joining the battery substrate.

A battery comprises a battery cell being in a rectangular plate shape on whose one side face a negative electrode terminal and a positive electrode terminal are arranged; a battery substrate having an external connection terminal which is electrically connected to the negative electrode terminal and the positive electrode terminal, and being arranged facing the side face so that the external connection terminal is positioned on the approximate center of the longitudinal side of the side face; a terminal cover which is arranged so as to cover the battery substrate and explode the external connection terminal; and resin mold sections arranged on both sides of the terminal cover in the longitudinal direction.

Accordingly, as the external connection terminal 10a is arranged on the center, and as the battery substrate is encapsulated by the two resin mold sections 16a, 16b on both longitudinal sides of the side face of the battery cell facing the external connection terminal 10a, it is possible to broaden an adhesion area between the resin material and the battery cell 11 around the external connection terminal 10a and to prevent the resin material from being exfoliated. Moreover, the external connection terminal 10a is arranged on the substantially longitudinal center of the upper face 11a. Therefore, when the battery 10 is loaded into the housing section Sh of the mobile phone S, it is possible to prevent the battery 10 from being inserted with inclination, and to reduce stress applied to the connector Sc.

In addition, the resin mold sections are respectively formed by injecting the resin material from injecting gates provided on the resin mold forming die. The injecting gates are arranged facing the side face on both longitudinal sides of the terminal cover.

Accordingly, as the resin material is injected into the resin mold sections 16a, 16b on both sides of the upper face 11a from injecting gates 19a provided on the resin mold forming die 19 facing those respectively, the resin material is injected into both sides of the external connection terminal 10a appropriately, and it is possible to prevent the resin mold sections 16a, 16b on both sides from being exfoliated. Moreover, it is preferable to arrange injecting gates 19a so as to inject the resin material toward the upper face 11a of the battery cell 11. In this case, both resin mold sections 16a, 16b are molded on the condition that the battery substrate 14 is pressed against the upper face 11a of the battery cell 11 by the resin material injected. Therefore, the battery substrate 14 can be appropriately mounted on the battery cell 11.

The terminal cover is mounted on the battery substrate having an external connection terminal, and the resin mold sections are integrally joined to the terminal cover. Therefore, as surroundings of the external connection terminal 10a are covered with the terminal cover 15, it is possible to protect the surroundings of the external connection terminal 10a with the terminal cover 15 and to improve strength of surroundings. Moreover, as the resin mold sections 16a, 16b are joined to the terminal cover 15 as well as the battery cell 11, it is possible to position the battery substrate 14 on a predetermined position accurately.

The battery has a battery label wrapping the joint positions of the terminal cover and the resin mold sections. Therefore, as the battery label 20 is attached across the resin mold sections 16a, 16b and the upper face 11a of the battery cell 11, both resin mold sections 16a, 16b is strongly joined to the battery cell 11, and exfoliation of both resin mold sections 16a, 16b is prevented.

The battery label is attached to cover the entire surface formed by the terminal cover integrated with the battery cell and the resin mold sections. Therefore, as the terminal cover 15 is also joined to the battery cell 11 by the battery label 20, the terminal cover is strongly joined to the battery cell 11, and firmly mounted to the battery substrate 14. In addition, both resin mold sections 16a, 16b joined to the terminal cover 15 are strongly joined to the battery cell 11, so that it is possible to prevent the exfoliation of the resin mold sections 16a, 16b more certainly.

In this way, according to this embodiment, a battery cell being in a rectangular plate shape has a negative electrode terminal and a positive electrode terminal on one side face. An external connection terminal electrically connected to the negative electrode terminal and positive electrode terminal and provided in a battery substrate is arranged on the approximate center of the side face in the longitudinal direction, and a terminal cover covering the side face and exploding the external connection terminal is arranged on the side face. Resin mold sections are arranged on both sides of the terminal cover. Therefore, after a molding process using the low-temperature molding resin has been performed on the battery cell, there is no concern about exfoliation of the low-temperature molding resin and generation of a short mold where the low-temperature molding resin is not filled. Accordingly, it is easy to set the molding conditions.

A battery unit according to this embodiment has a battery cell being in a rectangular plate shape on whose side face a negative electrode terminal and a positive electrode terminal are arranged, a battery substrate arranged on the side face of the battery cell and having an external connection terminal electrically connected to the negative electrode terminal and the positive electrode terminal, a terminal cover mounted to cover the battery substrate and having an external terminal window exploding the external connection terminal, and a repulsion means placed between the battery cell and the battery substrate and for applying a compression repulsive force to the battery substrate toward the terminal cover.

The repulsion means is arranged with being compressed so that the battery substrate is contacted with the terminal cover closely by being biased to the terminal cover by the compression repulsive force. The repulsion means is a tape-shaped double-sided adhesive foam tape formed by providing adhesive layers on both surfaces of foam having a compression repulsive force.

Accordingly, as the repulsion means applies the compression repulsive force toward the terminal cover, the degree of contact between the battery substrate and the terminal cover becomes high, and it is possible to prevent the resin material from leaking into an exposed side of the external connection terminal. As the repulsion means is placed between the side face of the battery cell and the battery substrate, the compression repulsive force can be effectively applied. Moreover, the repulsion means is placed between the side face of the battery cell and the battery substrate, and it is composed of a double-sided adhesive foam tape that can adhere the battery substrate to the side face of the battery cell as well as can bias it in the thickness direction, so that adhering the battery substrate to the battery cell and applying the compression repulsive force toward the terminal cover can be done with one member. Therefore, it is possible not only to make the entire body be lightweight, but also to reduce an amount of the resin material.

The battery according to this embodiment also has resin mold sections on both sides of the terminal cover of the battery unit in a longitudinal direction of the side face. The resin mold sections are formed by resin-molding process using a resin material, and it covers the battery substrate and the terminal cover. Therefore, it is possible to realize a battery having effects acquired by the battery unit described above.

A method of producing a battery according to this embodiment comprises steps of forming a battery unit and forming resin mold sections. The step of forming a battery unit has arranging a battery substrate having an external connection terminal electrically connected to a negative electrode terminal and a positive electrode terminal through a repulsion means on a battery cell being in a rectangular plate shape on whose one side face the negative electrode terminal and the positive electrode terminal are arranged; and mounting a terminal cover including an external terminal window exploding the external connection terminal on the battery substrate. The battery unit is formed on a condition that a compression repulsive force is applied to the battery substrate toward the terminal cover. The step of forming resin mold sections has arranging the battery unit in a resin mold, and resin-molding using resin material. The resin mold sections are formed so as to cover the battery substrate and the terminal cover.

The battery unit is arranged in the resin mold forming die so that the terminal cover abuts the resin mold forming die. In addition, the resin mold forming die injects the resin material to a compressed direction of the repulsion means.

Therefore, it is possible to realize a battery producing method for producing a battery having effects that can be acquired by the above-described battery unit. Since the terminal cover abuts the resin mold forming die when producing the battery, the compression repulsive force of the repulsion means can be effectively applied.

In this way, in the battery unit according to this embodiment, a battery substrate including an external connection terminal electrically connected to a negative electrode terminal and a positive electrode terminal is arranged on one side face of battery cell being in a rectangular plate shape on whose one side face the negative electrode terminal and the positive electrode terminal are arranged, and a terminal cover which covers the battery substrate and includes an external terminal window exploding the external connection terminal is mounted. Between the battery cell and the battery substrate, a repulsion means for applying a compression repulsive force to the battery substrate toward the terminal cover is arranged. Therefore, when a resin-molding process is performed, the resin material injected is prevented form leaking into the external terminal window, and it is not happened that the external connection terminal is covered with the resin material.

1. A battery comprising:
a battery cell being in a rectangular plate shape on whose one side face a negative electrode terminal and a positive electrode terminal are arranged;
a negative electrode lead plate and a positive electrode lead plate whose one ends are respectively joined to the negative electrode terminal and positive electrode terminal, and which are arranged on the side face of the battery cell; and
a battery substrate having mounting metal plates respectively joined to the negative electrode lead plate and the positive electrode lead plate, and electrically connected to the negative electrode terminal and the positive electrode terminal through the mounting metal plates, the negative electrode lead plate and a positive electrode lead plate.

2. The battery according to claim 1, wherein the negative electrode lead plate is arranged so that a joint portion joined to the mounting metal plate is positioned on an edge side of one longitudinal side of the side face,
the positive electrode lead plate is arranged so that a joint portion joined to the mounting metal plate is positioned on an edge side of the other longitudinal side of the side face, and
the battery substrate is arranged between both joint portions of the negative electrode lead plate and the positive electrode lead plate.

3. The battery according to claim 1, wherein the mounting metal plate is mounted on the side face side of the battery substrate.

4. The battery according to claim 1, wherein the battery substrate has the mounting metal plate joined to the negative electrode lead plate on an edge side of one longitudinal side of the side face, and the mounting metal plate joined to the positive electrode lead plate on an edge side of the longitudinal other side of the side face.

5. The battery according to claim 1, wherein the battery substrate is integrated with the battery cell by being covered with a resin mold section.

6. The battery according to claim 1, wherein joint portions of the negative electrode lead plate and the positive electrode lead plate are arranged so as to form one plane along the side face.

7. The battery according to claim 1, wherein joining of the negative and positive electrode lead plates and the battery cell, and joining of the negative and positive electrode lead plates and the mounting metal plates of the battery substrate are performed in the same direction.

8. The battery according to claim 1, wherein the battery substrate has an external connection terminal electrically connected to the negative electrode terminal and the positive electrode terminal, and
the external connection terminal is positioned on the generally longitudinal center of the side face when the battery substrate is mounted facing the side face.

9. The battery according to claim 8, further comprising a terminal cover arranged so as to cover the battery substrate,
wherein the external connection terminal is exposed through an external terminal window provided on the terminal cover.

10. The battery according to claim 9, further comprising resin mold sections arranged on both longitudinal sides of the terminal cover, respectively.

11. The battery according to claim 10, wherein the resin mold sections are molded by injecting a resin material from injecting gates of a resin mold forming die arranged with facing the side face on both longitudinal sides of the terminal cover toward the side face on both sides of the terminal cover.

12. The battery according to claim 10, wherein the terminal cover is mounted on the battery substrate, and
the resin mold sections are integrally joined with the terminal cover.

13. The battery according to claim 12, further comprising a battery label that covers and wraps joint portions of the terminal cover and the resin mold sections.

14. The battery according to claim 1, wherein the battery substrate has an external connection terminal which is electrically connected to the negative electrode terminal and the positive electrode terminal, and exploded by a terminal cover arranged so as to cover the battery substrate, and
a repulsion means for applying a compression repulsive force to the battery substrate toward the terminal cover is arranged between the battery cell and the battery substrate.

15. The battery according to claim 14, wherein the repulsion means is arranged in a compressed state in order to closely contact the battery substrate with the terminal cover by biasing the battery substrate against the terminal cover with the compression repulsive force.

16. A method of producing a battery comprising steps of:
joining one ends of a negative electrode lead plate and a positive electrode lead plate to a negative electrode terminal and a positive electrode terminal, respectively, arranged on one side face of a battery cell being in a rectangular plate shape;
joining mounting metal plates which are provided on both sides of a battery substrate to the negative electrode lead plate and the positive electrode lead plate; and
injecting a resin material from a side facing the side face toward the battery substrate to form resin mold section by which the battery substrate is covered and integrated with the battery cell.
